(19) United States
(12) Patent Application Publication
(10) Pub. No.: US 2010/0050649 A1
(43) Pub. Date: Mar. 4, 2010

(54) COMBUSTOR DEVICE AND TRANSITION DUCT ASSEMBLY

(76) Inventor: David B. Allen, Oviedo, FL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/204,087

(22) Filed: Sep. 4, 2008

(51) Int. Cl. F02C 7/00

(52) U.S. Cl. 60/752; 415/182.1

(57) ABSTRACT

A combustor device and transition duct assembly is provided for use in a gas turbine engine. The combustor device comprises combustor structure having an exit portion; spring clips mounted to the exit portion of the combustor structure; and a burner assembly. The transition duct comprises a conduit having inlet and outlet sections and an abradable material layer provided along a circumferential portion of the inlet section of the transition duct conduit. The transition duct conduit inlet section may be coupled to the combustor structure exit portion such that the spring clips engage the abradable material layer.

### FIELD OF THE INVENTION

The present invention relates to a combustor device and transition duct assembly and, more particularly, to such an assembly having a transition duct comprising a conduit having an inlet section provided with an abradable material layer.

### BACKGROUND OF THE INVENTION

Gas turbine engines including a can-annular combustion system comprise a compressor and a turbine. The can-annular combustion system comprises a plurality of combustor devices and a like number of transition ducts. In one design, the combustor devices comprise a combustor device casing, a burner assembly, and a combustor device liner. Each transition duct is coupled to a corresponding combustor device liner. Compressed air enters each combustor device from the compressor, and is mixed with fuel in the burner assembly. The fuel and air mixture burns within the combustor device liner and transition duct to create hot combustion products defining a working gas. The working gases exit the transition duct into the turbine. The working gases expand in the turbine and cause blades coupled to a shaft and disc assembly to rotate.

The combustor device liner typically is provided with spring clips, which engage with an inlet section of the transition duct. The spring clips and transition duct conduit inlet section are typically in short amplitude vibrational contact with one another. The spring clips comprise a hard curved surface which engages a hard flat surface of the transition duct conduit inlet section. Hence, the spring clips make line contact with the transition duct conduit inlet section. In this implementation, the spring clips wear quickly.

### SUMMARY OF THE INVENTION

In accordance with a first aspect of the present invention, a combustor device and transition duct assembly is provided for use in a gas turbine engine. The combustor device comprises a casing; a liner coupled to the casing having an exit portion; spring clips mounted to the exit portion of the liner; and a burner assembly. The transition duct comprises a conduit having inlet and outlet sections and a compliant material layer provided on an inner circumferential portion of the inlet section of the conduit The transition duct conduit inlet section is fitted over the liner exit portion such that the spring clips engage the compliant material layer.

The compliant material layer may comprise a coating, such as CoNiCrAlY-hexagonalBn-Polyester. The compliant material layer may comprise a monolithic material layer, such as a fibermetal layer.

The outer surfaces of the spring clips may be provided with a hard chromium carbide material.

In accordance with a second aspect of the present invention, a combustor device and transition duct assembly is provided for use in a gas turbine engine. The combustor device comprises combustor structure having an exit portion; spring clips mounted to the exit portion of the combustor structure; and a burner assembly. The transition duct may comprise a conduit having inlet and outlet sections and an abradable material layer provided on a circumferential portion of the inlet section of the transition duct conduit. The transition duct conduit inlet section may be coupled to the combustor structure exit portion such that the spring clips engage the abradable material layer. The spring clips are adapted to wear into the abradable material layer.

The abradable material layer may comprise an abradable coating, such as CoNiCrAlY-hexagonalBn-Polyester The abradable material layer may comprise a monolithic abradable material layer, such as a fibermetal layer.

The outer surfaces of the spring clips may be provided with a hard chromium carbide material.

The combustor structure may comprise a casing and a liner coupled to the casing.

In accordance with a third aspect of the present invention, a transition duct is provided adapted to be coupled with a combustor device liner having spring clips mounted to an exit portion of the liner. The transition duct may comprise a conduit having inlet and outlet sections and an abradable material layer provided on a circumferential portion of the inlet section of the transition duct conduit. The transition duct conduit is adapted to be coupled to the liner exit portion such that the spring clips engage the abradable material layer.

### BRIEF DESCRIPTION OF THE DRAWINGS

FIG. 1 is a side view, partially in cross section, of a combustor device/transition duct assembly constructed in accordance with the present invention;

FIG. 2 is an enlarged cross sectional view of a portion of the liner exit portion and the transition duct conduit inlet section of the combustor device/transition duct assembly illustrated in FIG. 1;

FIG. 3 is a side view, partially in cross section, of the combustor device/transition duct assembly illustrated in FIG. 1; and

FIG. 4 is a view looking into the inlet section of the transition duct of the combustor device/transition duct assembly illustrated in FIG. 1.

### DETAILED DESCRIPTION OF THE INVENTION

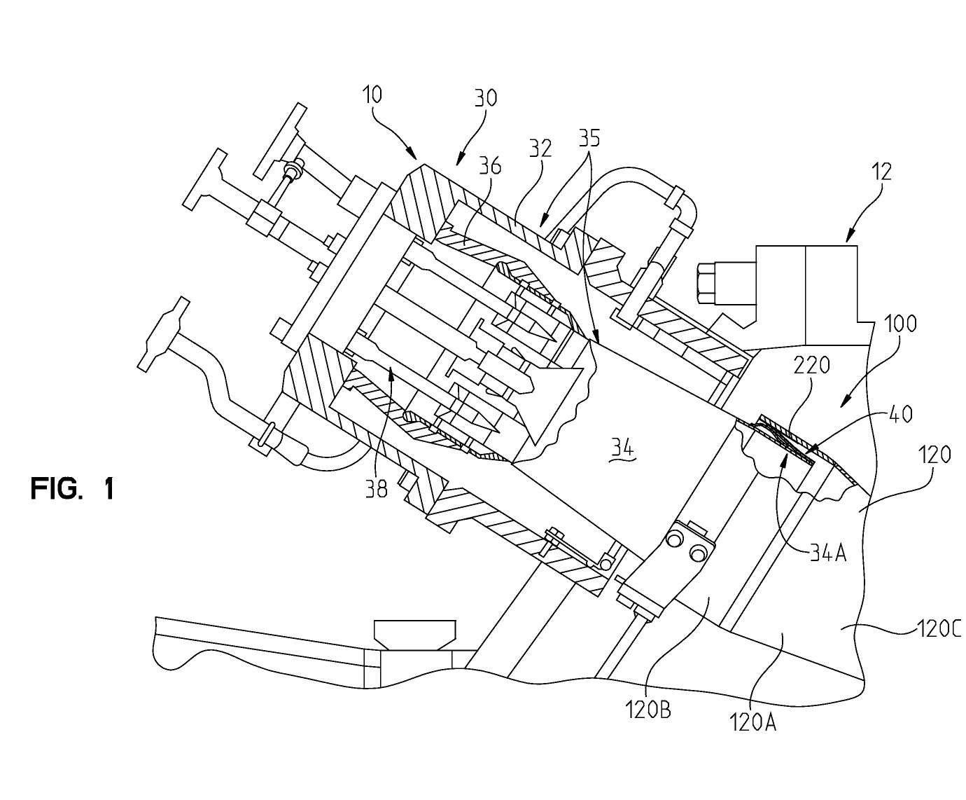

A portion of a can-annular combustion system 10, constructed in accordance with the present invention, is illustrated in FIG. 1. The combustion system 10 forms part of a gas turbine engine. The gas turbine engine further comprises a compressor (not shown) and a turbine (not shown). Air enters the compressor, where it is compressed to elevated pressure and delivered to the combustion system 10, where the compressed air is mixed with fuel and burned to create hot combustion products defining a working gas. The working gases are routed from the combustion system 10 to the turbine. The working gases expand in the turbine and cause blades coupled to a shaft and disc assembly to rotate.

The can-annular combustion system 10 comprises a plurality of combustor device/transition duct assemblies 100. Each assembly 100 comprises a combustor device 30 and a corresponding transition duct 120. The combustor device and transition duct assemblies 100 are spaced circumferentially apart and coupled to an outer shell 12 of the gas turbine engine. Each transition duct 120 receives combustion products from its corresponding combustor device 30 and defines a path for those combustion products to flow from the combustor device 30 to the turbine.

Only a single combustor device and transition duct assembly 100 is illustrated in FIG. 1. Each assembly 100 forming part of the can-annular combustion system 10 may be constructed in the same manner as the combustor device and transition duct assembly 100 illustrated in FIG. 1. Hence, only the combustor device and transition duct assembly 100 illustrated in FIG. 1 will be discussed in detail here.

The combustor device 30 of the assembly 100 illustrated in FIG. 1 comprises a combustor casing 32, shown in FIG. 1, coupled to the outer shell 12 of the gas turbine engine. The combustor device 30 further comprises a liner 34 and a burner assembly 38, see FIG. 1. The liner 34 is coupled to the combustor casing 32 via support members 36. In the illustrated embodiment, the liner 34 comprises a closed curvilinear liner such as a generally cylindrical liner. The liner 34 may be formed from a material, such as Hastelloy-X. The burner assembly 38 is coupled to the combustor casing 32 and functions to inject fuel into the compressed air such that it mixes with the compressed air. The air and fuel mixture burns in the liner 34 and corresponding transition duct 120 so as to create hot combustion products. In the illustrated embodiment, the combustor casing 32 and liner 34 define a combustor structure 35. Alternatively, the combustor structure may comprise a liner coupled directly to the outer shell. In this alternative embodiment, the burner assembly may also be coupled directly to the outer shell.

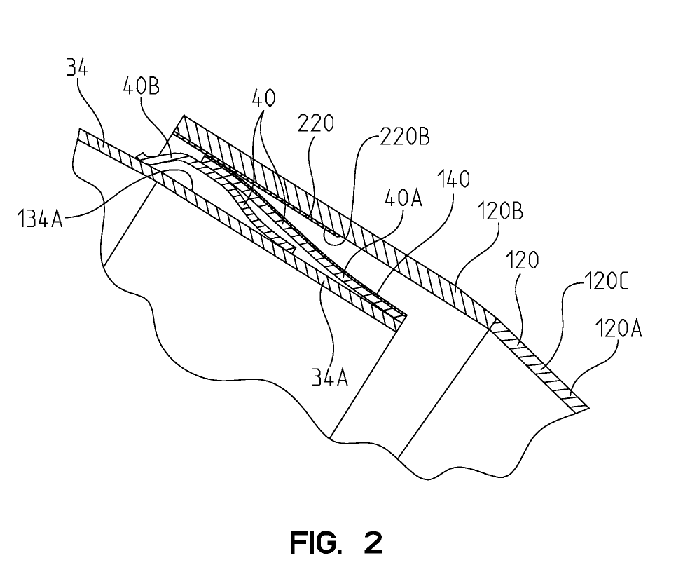

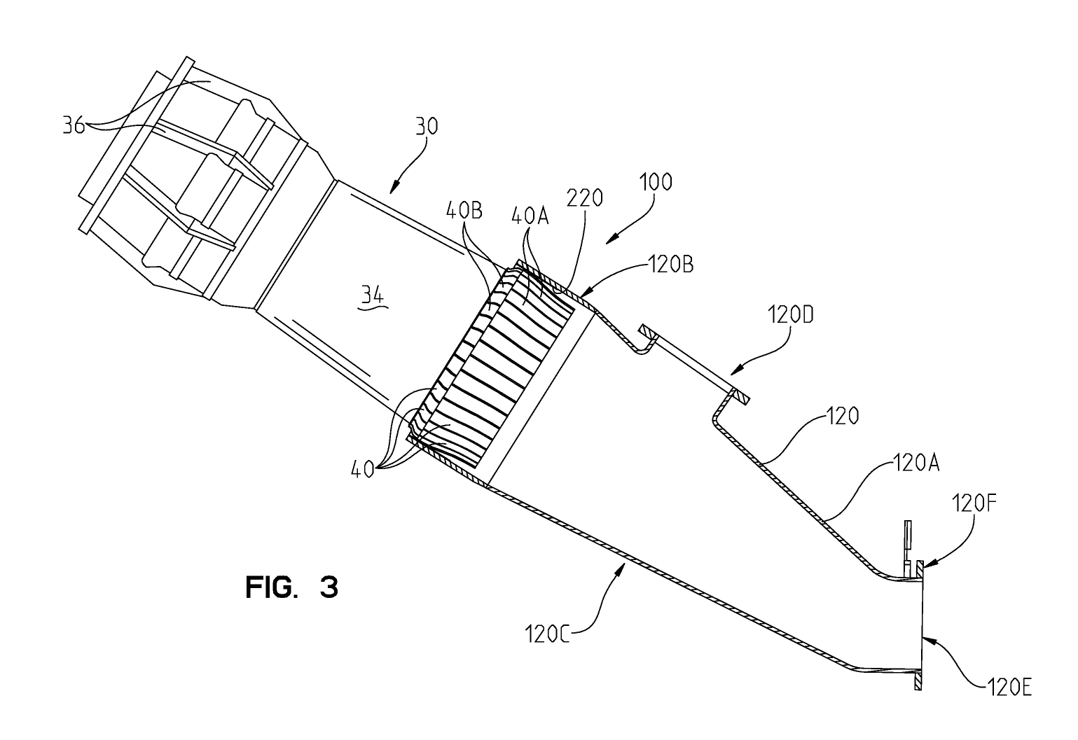

In the illustrated embodiment, the liner 34 comprises an exit portion 34A, see FIGS. 1-2. Spring clips 40 are mounted, such as by welding, to an outer circumferential surface 134A of the liner exit portion 34A, see FIGS. 1-3. In the illustrated embodiment, the spring clips 40 comprise upper spring clips 40A and lower spring clips 40B, see FIGS. 2 and 3. The upper and lower spring clips 40A and 40B may be formed from a material, such as Inconel X-750. The upper spring clips 40A may be provided with a wear resistance material 140, see FIG. 2, such as a hard chromium carbide material. The chromium carbide material may be spray applied to the spring clips 40A via a high-velocity oxy-fuel thermal spray technique. The wear resistant material 140 may comprise other wear resistant materials capable of withstanding the hot environment of a gas turbine engine and may be applied using application methods such as, but not limited to, air plasma spray (APS), weld cladding, plating, brazing and the like.

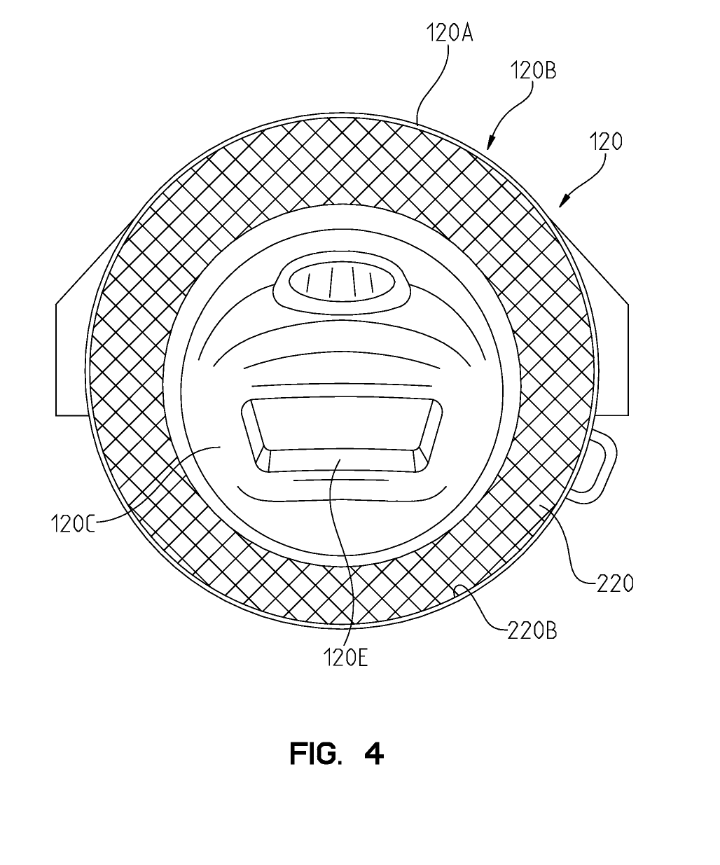

The transition duct 120 may comprise a conduit 120A having a generally cylindrical inlet ring or inlet section 120B, a main body portion 120C, a bypass flange 120D and a generally rectangular outlet section 120E, see FIGS. 3 and 4. A collar 120F is coupled to the conduit outlet section 120E, see FIG. 3. The conduit 120A and collar 120F may be formed from a material such as Hastelloy-X, Inconel 617 or Haynes 230. The conduit inlet section 120B may have a thickness of from about 0.4 inch to about 0.7 inch. The bypass flange 120D may be coupled to combustor bypass piping (not shown). The collar 120F is adapted to be coupled to a row 1 vane segment (not shown).

The inlet section 120B of the transition duct 120 is fitted over the liner exit portion 34A and the liner spring clips 40, see FIG. 1-3. In the illustrated embodiment, a material layer 220 is provided on an inner circumferential portion 220B of the inlet section 1208 of the transition duct conduit 120A, see FIGS. 2 and 4. The material layer 220 is positioned within the transition duct conduit 120A so that the spring clips 40 engage the material layer 220. The spring clips 40 and transition duct conduit inlet section 1208 are typically in short amplitude vibrational contact with one another. Preferably, the material layer 220 is formed from a material that is abradable relative to the material from which the spring clips 40 are formed such that the spring clips 40 wear into the abradable material layer 220 over time, i.e., during use/operation of the gas turbine engine. As the spring clips 40 wear into the abradable material layer 220, the force applied by the spring clips 40 to the transition duct conduit inlet section 120B is dissipated over an area larger than line contact, as discussed in the Background of the Invention section. Hence, it is believe that the contact pressure between the spring clips 40 and the material layer 220/transition duct conduit inlet section 120B will be lower than the prior art line contact resulting in reduced wear of the spring clips 40. The spring clips 40 in engagement with the material layer 220/transition duct conduit inlet section 120B seal the liner exit portion 34A with the inlet section 120B so as to prevent or minimize cool compressed gases from passing into the transition duct conduit inlet section 1208.

It is further contemplated that the material layer 220 may be formed from a material that is not only abradable but is soft/compliant to allow the spring clips 40 to deform into the soft or compliant material layer 220 upon contact. By deforming the soft/compliant material layer 220, it is believed that the contact pressure between the spring clips 40 and the material layer 220/transition duct conduit inlet section 120B will be lower than the prior art line contact resulting in reduced wear of the spring clips 40.

The material layer 220 may comprise a soft/compliant abradable coating, such as a CoNiCrAlY-hexagonalBn-Polyester coating, which may be applied via a thermal spray coating operation. The thermal spray coating process may comprise a combustion spray process or an air plasma spray process. The material layer coating may have a thickness of from about 0.05 inch to about 0.15 inch. It is believed that the hexagonal boron nitride acts as a lubricating phase, which further reduces wear of the spring clips 40. It is further contemplated that other materials may be used in forming the material layer 220 so long as they are able to withstand the high temperatures within the combustion system 10 and are abradable or soft/compliant/abradable. These other materials may further include a lubricating phase such as hexagonal boron nitride or graphite to further reduce spring clip wear.

It is also contemplated that the material layer 220 may comprise a monolithic soft/compliant and abradable material layer, such as a fibermetal layer. Example fibermetal layers include Feltmetal material formed from Hastelloy-X material, Haynes 188 material, or FeCrAlY material. Feltmetal formed from these three materials is commercially available from Technetics Corporation, DeLand, Fla. The fibermetal layer 220 may have a thickness of from about 0.05 inch to about 0.15 inch and may be brazed to the inner circumferential portion 220B of the conduit inlet section 120B.

### TEST EXAMPLES

A fretting test rig from Sulzer-Innotec (Winterthur Switzerland) was used. A sample of Feltmetal material formed from Hastelloy-X material having a thickness of 2.0 mm (0.08 inch) was tested. The test rig comprised a reciprocating rod-shaped metal slider tool having a substantially planar contact surface formed from Inconel 939 in engagement with the Feltmetal sample. Inconel 939 has a hardness generally similar to that of Inconel X-750 and both Inconel 939 and Inconel X-750 are substantially harder than Feltmetal. The test temperature was 538 degrees C., the test frequency, i.e., reciprocating metal slider frequency, was 800 Hz, the cyclic amplitude or test metal slider stroke was 10 microns, a normal load of 35 N was applied to the reciprocating metal slider, and the total number of cycles was 483,800,000 for a total sliding distance of 9676 meters. It was observed that there was a distinct wear pattern in the Feltmetal sample while there was a complete lack of wear of the metal slider tool.

Thermally sprayed abradable coatings have also been tested in the aforementioned fretting test rig. In one test, a commercially available 75%/25% (percent by weight) Nickel/Graphite powder was obtained from Sulzer Metco, designated Metco 307NS. A Metco 6P-II flame spray torch was used to apply a coating of the 75%/25% Ni/Gr material, having a thickness of 0.100 inch, to a 1018 steel substrate using the spray parameters listed below. After spraying, the carbon content of the 75%/25% Ni/Gr coating was measured by a Leco carbon analyzer and was determined to be 14 wt % of the total weight of the coating. The hardness of the coating was measured via Rockwell HR15Y hardness to be 45 HR15Y. Testing was conducted as described above for the Feltmetal sample and excellent results were obtained. The 75%/25% coating was preferentially worn away, leaving behind distinct grooves accurately representing the mating counterface, which was an IN-939 slider as before. No measurable wear was detected on the IN-939 slider after approximate 9000 meters of sliding.

### Metco 307NS Spray Parameters:

| | |
|---|---|
| Nozzle: | 6P 7A-M |
| Siphon Plug: | 6P 205 |
| Air Cap: | 6P 4 |
| O2 Pressure, psi: | 40 |
| Acetylene | 15 |
| Pressure, psi: | |
| Nitrogen carrier | 55 |
| gas pressure, PSI | |
| O2 Flow (Metco | 48 |
| FMR): | |
| Acetylene Flow, | 56 |
| Metco FMR: | |
| Powder Feeder: | 3MP |
| Meter Wheel: | H |
| Meter Wheel rpm: | 35 |
| Spray Distance, | 12 |
| inches: | |
| Spray Rate, lb/hr: | 8 |
| Deposit Efficiency, | 80 |
| %: | |

Hence, based on these test results, it is believed that an abradable material layer provided on the transition duct conduit inlet section 120B will result in reduced wear of the spring clips 40.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A combustor device and transition duct assembly for use in a gas turbine engine comprising:
a combustor device comprising:
a casing;
a liner coupled to said casing and having an exit portion;
spring clips mounted to said exit portion of said liner; and
a burner assembly; and
a transition duct comprising a conduit having inlet and outlet sections and a compliant material layer provided on an inner circumferential portion of said inlet section of said conduit, wherein said transition duct conduit inlet section is fitted over said liner exit portion such that said spring clips engage said compliant material layer.

2. The assembly as set out in claim 1, wherein said compliant material layer comprises a coating.

3. The assembly as set out in claim 2, wherein said coating comprises CoNiCrAlY-hexagonalBn-Polyester.

4. The assembly as set out in claim 1, wherein said compliant material layer comprises a monolithic material layer.

5. The assembly as set out in claim 4, wherein said monolithic material layer comprises a fibermetal layer.

6. The assembly as set out in claim 1, wherein outer surfaces of said spring clips are provided with a hard chromium carbide material.

7. A combustor device and transition duct assembly for use in a gas turbine engine comprising:
a combustor device comprising:
combustor structure having an exit portion;
spring clips mounted to said exit portion of said liner;
a burner assembly coupled to said combustor structure;
a transition duct comprising a conduit having inlet and outlet sections and an abradable material layer provided on a circumferential portion of said inlet section of said transition duct conduit, wherein said transition duct conduit inlet section is coupled to said combustor structure exit portion such that said spring clips engage said abradable material layer, wherein said spring clips are adapted to wear into said abradable material layer.

8. The assembly as set out in claim 7, wherein said abradable material layer comprises an abradable coating.

9. The assembly as set out in claim 8, wherein said abradable coating comprises CoNiCrAlY-hexagonalBn-Polyester.

10. The assembly as set out in claim 7, wherein said abradable material layer comprises a monolithic abradable material layer.

11. The assembly as set out in claim 10, wherein said monolithic abradable material layer comprises a fibermetal layer.

12. The assembly as set out in claim 7, wherein outer surfaces of said spring clips are provided with a hard chromium carbide material.

13. The assembly as set out in claim 7, wherein said combustor structure comprises a casing and a liner coupled to said casing.

14. A transition duct adapted to be coupled with a combustor device liner having spring clips mounted to an exit portion of the liner comprising:
a conduit having inlet and outlet sections and an abradable material layer provided on a circumferential portion of said inlet section of said transition duct conduit, wherein said transition duct conduit is adapted to be coupled to the liner exit portion such that the spring clips engage said abradable material layer.

15. The transition duct as set out in claim 14, wherein said abradable material layer comprises an abradable coating.

16. The transition duct as set out in claim 15, wherein said abradable coating comprises CoNiCrAlY-hexagonalBn-Polyester.

17. The transition duct as set out in claim 14, wherein said abradable material layer comprises a monolithic abradable material layer.

18. The transition duct as set out in claim 17, wherein said monolithic abradable material layer comprises a fused fibermetal layer.

19. The transition duct as set out in claim 14, wherein said abradable material layer is provided along an inner circumferential portion of said inlet section of said transition duct.
